(19) United States
(12) Patent Application Publication
(10) Pub. No.: US 2005/0190800 A1
(43) Pub. Date: Sep. 1, 2005

(54) Method and apparatus for estimating noise power per subcarrier in a multicarrier system

(75) Inventors: Alexander Maltsev, Nizhny Novgorod (RU); Ali Sadri, San Diego, CA (US); Alexei Davydov, Nizhny Novgorod (RU)

Correspondence Address: The Law Offices of John C. Scott, LLC;c/o PortfolioIP, P.O. Box 52050, Minneapolis, MN, 55402, US

(73) Assignee: Intel Corporation

(21) Appl. No.: 10/742,015

(22) Filed: Dec. 17, 2003

(51) Int. Cl. H04J 3/22

(52) U.S. Cl. 370/914

(57) ABSTRACT

Noise power is estimated for subcarriers in a multicarrier system by first decoding a received multicarrier signal and then using the decoded signal information and the received signal information to perform the estimation. Soft decision or hard decision decoding may be used. In at least one embodiment, channel estimates are also made using the decoded signal information and the received signal information.

### FIELD OF THE INVENTION

The invention relates generally to wireless communications and, more particularly, to parameter estimation techniques for use in multicarrier wireless systems.

### BACKGROUND OF THE INVENTION

Multicarrier communication is a technique for transmitting data that divides the data into multiple pieces and then transmits the pieces in parallel via a number of separate narrowband carriers (i.e., sub-carriers). Multicarrier communication may be used to overcome intersymbol interference in channels by increasing the symbol period of the carrier, thus limiting the data rate transmitted through each sub-channel (i.e., by each sub-carrier). When the symbol period transmitted through a sub-channel is longer than the maximum multipath delay in the channel, the effect of intersymbol interference may be reduced significantly. Because multiple carriers are used, relatively high data rates may be achieved overall using multicarrier techniques.

One type of multicarrier communication that is growing in popularity is orthogonal frequency division multiplexing (OFDM). OFDM has already been adopted for use in the IEEE 802.11a wireless networking standard (IEEE Std 802.11a-1999) and in other wireless standards. Strategies are now being considered for improving the throughput of OFDM systems and other multicarrier communication systems. One such strategy involves the use of adaptive modulation techniques. To implement at least some of these techniques, bit and power loading algorithms (BPLA) may be required that need accurate information about noise power per subcarrier, in addition to channel transfer function information (e.g., channel gains per subcarrier, etc.).

### BRIEF DESCRIPTION OF THE DRAWINGS

FIG. 1 is a block diagram illustrating an example wireless apparatus in accordance with an embodiment of the present invention;

FIG. 2 is a block diagram illustrating an example wireless apparatus in accordance with another embodiment of the present invention; and

FIG. 3 is a flowchart illustrating an example method for use in estimating noise power per subcarrier in a multicarrier system in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

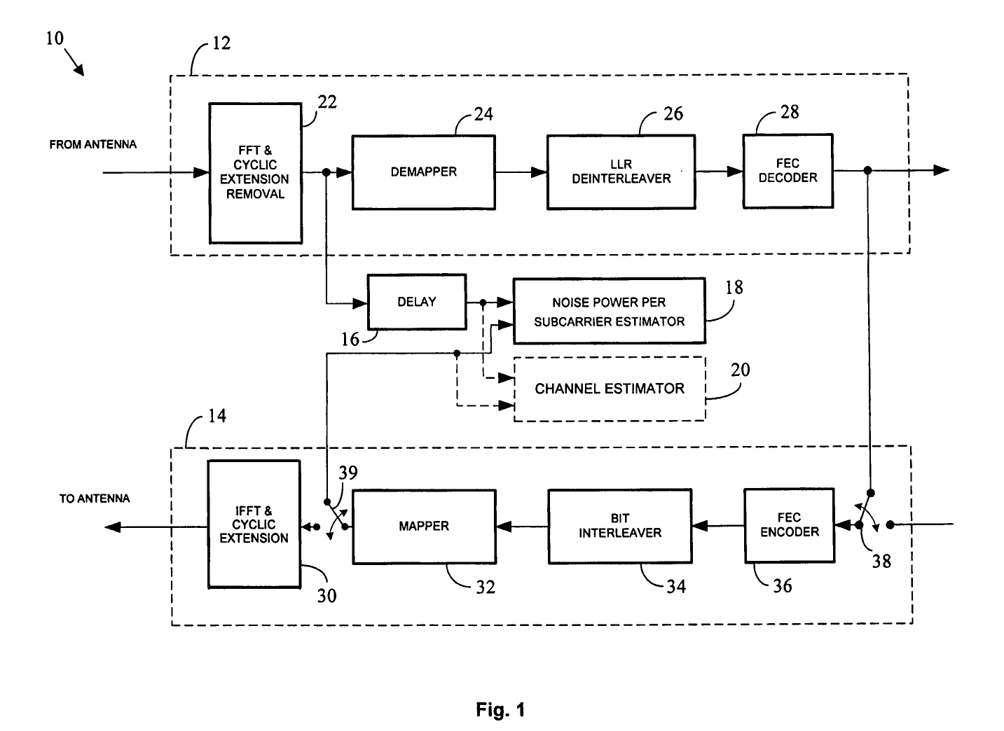

FIG. 1 is a block diagram illustrating an example wireless apparatus 10 in accordance with an embodiment of the present invention. The wireless apparatus 10 is capable of estimating noise power per subcarrier for multicarrier signals received from a wireless channel. The noise power per subcarrier estimates may then be used to implement adaptive modulation techniques and/or they may be used in some other manner. The wireless apparatus 10 of FIG. 1 will be described in the context of an OFDM-based system, but it should be appreciated that some or all of the inventive principles may be used in connection with any multicarrier communication technique. The wireless apparatus 10 may be implemented within any type of wireless device, component, or system that uses multicarrier communication techniques including, for example, wireless client devices for use within wireless networks; wireless access points; wireless network interface cards (NICs) and other wireless network interface structures; cellular telephones and other handheld wireless communicators; pagers; laptop, desktop, palmtop, and tablet computers with wireless networking capabilities; personal digital assistants (PDAs) with wireless networking capabilities; radio frequency integrated circuits (RFICs); and/or others.

With reference to FIG. 1, the wireless apparatus 10 may include at least one of: a receiver chain 12, a transmitter chain 14, a delay 16, a noise power per subcarrier estimator 18, and a channel estimator 20. The receiver chain 12 may include: a fast Fourier transform (FFT) and cyclic extension removal block 22, a demapper 24, a log likelihood ratio (LLR) deinterleaver 26, and a forward error correction (FEC) decoder 28. The transmitter chain 14 may include: a FEC encoder 36, a bit interleaver 34, a mapper 32, an inverse fast Fourier transform (IFFT) and cyclic extension block 30, and switches 38, 39. During operation, a multicarrier signal is received by an antenna and delivered to an input of the receiver chain 12. The receiver chain 12 then decodes the received signal in a predetermined manner. The decoded signal information may then be delivered to the transmitter chain 14 where it is reconstructed into decoded signal points. The decoded signal points may then be input to the noise power per subcarrier estimator 18 along with a delayed version of the originally received signal points. The noise power per subcarrier estimator 18 then uses this information to estimate the noise power associated with the various subcarriers of the multicarrier arrangement. In at least one embodiment, a channel estimator 20 is also provided that may use the same input information to estimate channel parameters for the wireless channel.

Any type of antenna may be used to receive signals from the wireless channel including, for example, a dipole antenna, a patch antenna, a helix antenna, an antenna array, and/or others. Antenna diversity techniques may also be used. Additional circuitry may also be located between the antenna and the input of the receiver chain 12 (e.g., RF processing circuitry, etc.).

The FFT and cyclic extension removal block 22 is operative for first removing a cyclic extension from a received OFDM symbol and then transforming the OFDM symbol from a time domain representation to a frequency domain representation. The frequency domain representation of the OFDM symbol will typically include a signal point (e.g., in-phase and quadrature components) for each subcarrier of the received OFDM symbol. This signal point may be different from the one that was originally transmitted to the apparatus 10 due to the effects of, for example, noise and distortion in the wireless channel. The demapper 24 demaps the information output by the FFT and cyclic extension removal block 22 based on the signal constellation of the associated modulation scheme (e.g., quadrature amplitude modulation (QAM), etc.). Because the signal points output by the FFT and cyclic extension removal block 22 may not correspond exactly to constellation points in the corresponding signal constellation, the data output of the demapper 24 may have errors. In some embodiments, the demapper 24 may also output error information to specify, for example, a distance between a received signal point and the corresponding (selected) constellation point and/or confidence information to specify a confidence level that output data is accurate. The LLR deinterleaver 26 deinterleaves the data output by the demapper 24 in a predetermined manner. The FEC decoder 28 then decodes the deinterleaved data based on a error correction code. The FEC decoder 28 has the capability of correcting errors within the received data, so that the output of the FEC decoder 28 is a more accurate representation of the data that was actually transmitted to the wireless apparatus 10.

In the embodiment illustrated in FIG. 1, the FEC encoder 36, the bit interleaver 34, and the mapper 32 within the transmitter chain 14 are used to reconstruct signal points, using the decoded data output by the FEC decoder 28, for use by the noise power per subcarrier estimator 18. The switches 38, 39 may be used to direct the decoded data from the FEC decoder 28, through the appropriate portion of the transmitter chain 14, and to the noise power per subcarrier estimator 18 during noise power per subcarrier estimation operations. During normal transmitter activity, the switches 38, 39 may be set to allow transmit information to flow directly through the transmitter chain 14 from the input to the output thereof (and subsequently to a transmit antenna). In other embodiments, the FEC encoder 36, the bit interleaver 34, and the mapper 32 may be dedicated units that are not part of an associated transmitter chain (e.g., dedicated for use in estimating noise power per subcarrier and/or other parameters). During noise power per subcarrier estimation operations, the FEC encoder 36 encodes the decoded information received from the FEC decoder 28 using the corresponding forward error correction code. The bit interleaver 34 interleaves the data in an appropriate manner and the mapper 32 maps the interleaved data into the appropriate signal constellation. The signal points output by the mapper 32 are then delivered to the noise power per subcarrier estimator 18. The IFFT and cyclic extension unit 30 will not typically be used during noise power per subcarrier estimation operations. During transmit operations, however, the IFFT and cyclic extension unit 30 is used to convert mapped signal points output by the mapper 32 from a frequency domain representation to a time domain representation and then to add a cyclic extension to the time domain samples to form an OFDM symbol. The OFDM symbol may then be delivered to a transmit antenna for transmission into a wireless channel.

The delay 16 is operative for delaying the received signal points output by the FFT and cyclic extension removal block 22 to allow for the processing delay of the information through the remainder of the receive chain 12 and the FEC encoder 36, bit interleaver 34, and mapper 32 of the transmitter chain 14. In this manner, the delayed information may reach the input of the noise power per subcarrier estimator 18 at about the same time as the reconstructed (decoded) signal points. Any form of delay may be used. In at least one embodiment, the delay is implemented using a memory that simply holds the received signal point information until an appropriate time.

The noise power per subcarrier estimator 18 processes the received signal points and the reconstructed signal points to estimate the noise power associated with the various subcarriers of the system. In at least one embodiment, estimates are determined based on a single received OFDM symbol. In other embodiments, the estimates are averaged over a number of received OFDM symbols. For example, in one approach, the following equation is used to perform the noise power per subcarrier estimation:

$${σ}_{k}^{2} = \frac{1}{N - 1} {\sum }_{i = 1}^{N} {\vert {D}_{k , i} - {R}_{k , i} \vert}^{2}$$

where k is the subcarrier index, i is the OFDM symbol number, R_{k,i} is the received and equalized signal point, D_{k,i} is the reconstructed (decoded) signal point, and N is the number of OFDM symbols used for averaging. It is assumed in the above equation that the frequency domain channel transfer function has been estimated and the received signal has been equalized (so that, for example, the average received signal power is equal to unity and the value of noise power per subcarrier estimated with the equation coincides with the value of noise to signal ratio (NSR) per subcarrier). In at least one embodiment of the invention, smoothing is performed in the frequency domain across a group of neighboring subcarriers to improve the noise power per subcarrier estimation. To perform this smoothing, as a first step, the average normalized noise power for the group of subcarriers may be calculated using the following equation:

$${\tilde{σ}}_{norm , k}^{2} = {\sum }_{l = k - {N}_{s} / 2}^{{N}_{s} / 2} w ( l ) {\vert {λ}_{l} \vert}^{2} ( \frac{1}{N - 1} {\sum }_{i = 1}^{N} {\vert {D}_{l , i} - {R}_{l , i} \vert}^{2} )$$

where w(l) is a windowing function over Nₛ+1 subcarriers and λₗ is a channel transfer function value associated with the lth subcarrier. After the average normalized noise power has been calculated, the noise to signal power ratio (NSR) on each subcarrier within the group can be calculated using the following equation:

$${\tilde{σ}}_{k}^{2} = \frac{{\tilde{σ}}_{norm , k}^{2}}{{\vert {λ}_{k} \vert}^{2}}$$

By grouping subcarriers in this manner and averaging, the accuracy of the estimation may be increased. In a narrowband or frequency selective interference environment, however, the grouping of subcarriers may provide unreliable information about noise-power per subcarrier. Therefore, the above-described estimation approach (i.e., using smoothing) should only be used when, for example, the bandwidth of the grouped subcarriers is less than the bandwidth (or coherence bandwidth) of the interference. Other techniques for calculating noise power per subcarrier using received signal information and decoded signal information may alternatively be used.

As described above, in at least one embodiment of the present invention, a channel estimator 20 is provided that may estimate channel parameters for the wireless channel using the received signal points and the reconstructed (decoded) signal points described above. These channel estimates may be used, for example, to improve equalization performance or in some other manner. In at least one approach, the following equation may be used to generate the channel estimates:

$${\tilde{λ}}_{k , i} = \frac{1}{N} {\sum }_{l = i - N + 1}^{i} \frac{{R}_{k , l} \cdot {D}_{k , l}^{*}}{{\vert {D}_{k , l} \vert}^{2}}$$

where \tilde{λ}_{k,i} is the improved channel coefficient estimate for the kth subcarrier after the ith OFDM symbol and ( )* is the complex conjugate operator. Other techniques for estimating channel parameters using received signal information and decoded signal information may alternatively be used.

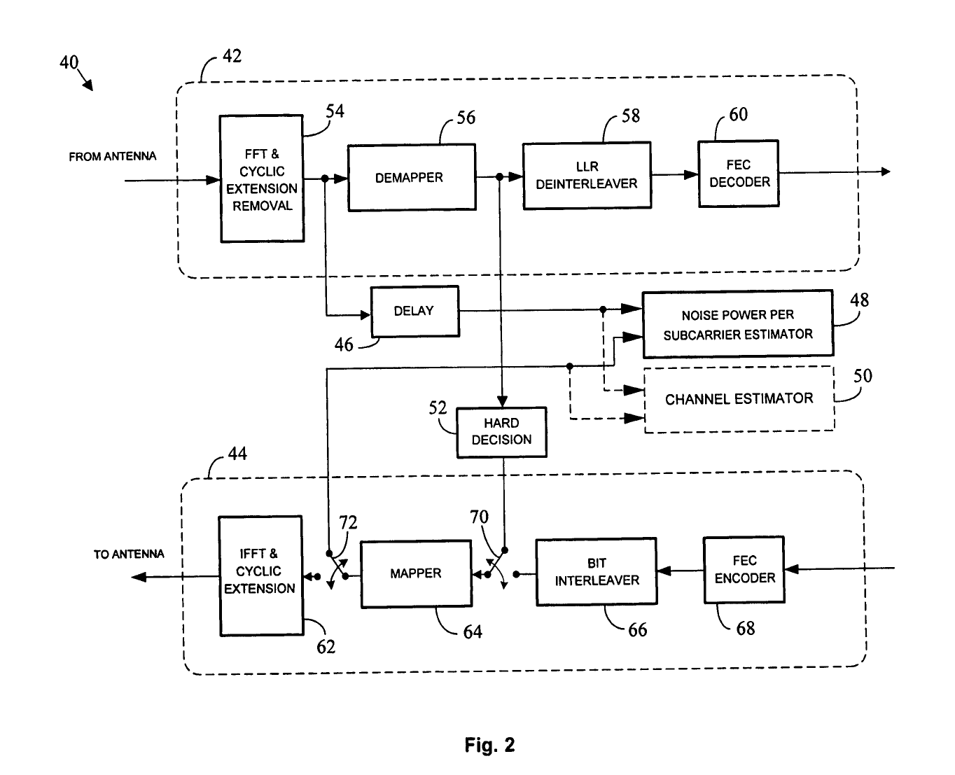

FIG. 2 is a block diagram illustrating an example wireless apparatus 40 in accordance with an embodiment of the present invention. As illustrated, the wireless apparatus 40 may include at least one of: a receiver chain 42, a transmitter chain 44, a delay 46, a noise power per subcarrier estimator 48, and a channel estimator 50. The receiver chain 42 may include: a fast Fourier transform (FFT) and cyclic extension removal block 54, a demapper 56, an LLR deinterleaver 58, and a FEC decoder 60. The transmitter chain 44 may include: a FEC encoder 68, a bit interleaver 66, a mapper 64, an IFFT and cyclic extension block 62, and switches 70, 72. The wireless apparatus 40 operates in a similar fashion to the apparatus 10 of FIG. 1. However, instead of processing demapped information through the LLR deinterleaver 58, the FEC decoder 60, the FEC encoder 68, and the bit interleaver 66, the information is directed to a hard decision unit 52 for decoding. Any form of hard decision device or structure may be used that computes the sign of LLR, which corresponds to the hard decision value.

The switches 70, 72 may be used to couple the output of the hard decision unit 52 through the mapper 64 and to an input of the noise power per subcarrier estimator 48 during noise power per subcarrier estimation operations. During normal transmitter activity, the switches 70, 72 may be set to allow transmit information to flow directly through the transmitter chain 44 from the input to the output thereof. In other embodiments, a dedicated mapper 64 may be provided for use in noise power per subcarrier estimation that is not part of an associated transmitter chain. The mapper 64 maps the decoded information into the appropriate signal constellation. The resulting signal points are then delivered to the noise power per subcarrier estimator 48. As before, the delay 46 delays the received signal points output by the FFT and cyclic extension removal block 54 to allow for the processing delay through the demapper 56, the hard decision unit 52, and the mapper 64. The noise power per subcarrier estimator 48 receives the delayed received signal points and the reconstructed, decoded signal points and uses them to estimate the noise power per subcarrier. In at least one embodiment, the noise power per subcarrier estimator 48 uses one or more of the previously described equations to estimate the noise power per subcarrier information. Other techniques may alternatively be used. As described previously, a channel estimator 50 may also be provided to estimate channel parameters using the reconstructed signal points and the delayed received signal points.

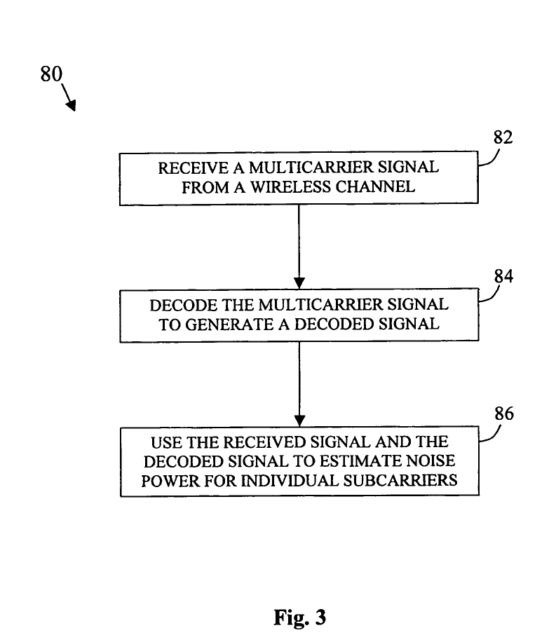

FIG. 3 is a flowchart illustrating an example method 80 for use in estimating noise power per subcarrier in a multicarrier communication system in accordance with an embodiment of the present invention. A multicarrier signal is first received from a wireless channel (block 82). In at least one embodiment, the multicarrier signal includes one or more OFDM symbols, although other types of multicarrier signal may alternatively be used. The multicarrier signal is subsequently decoded to generate a decoded signal (block 84). Any form of decoding may be used to decode the received signal, including both hard decoding techniques and soft decoding techniques. The received signal information and the decoded signal information are then used to estimate noise power for individual subcarriers (block 86). One or more of the equations discussed previously may be used to perform the estimations or other estimation techniques may be used. Channel estimations may also be performed using the received signal information and the decoded signal information.

It should be appreciated that the individual blocks illustrated in the block diagrams herein may be functional in nature and do not necessarily correspond to discrete hardware elements. For example, in at least one embodiment, two or more blocks within a diagram are implemented in software within a single (or multiple) digital processing device(s). The digital processing device(s) may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above. Hardware, software, firmware, and hybrid implementations may be made.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

1. A method comprising:
receiving a signal from a wireless channel, said signal being a multicarrier signal;
decoding said signal to generate a decoded signal; and
using said signal and said decoded signal to estimate noise power for individual subcarriers of said signal.

2. The method of claim 1, wherein:
decoding said signal includes forward error correction (FEC) decoding said signal.

3. The method of claim 1, wherein:
decoding said signal includes processing said signal in a hard decision decoder.

4. The method of claim 1, wherein:
decoding said signal includes processing said signal in a soft decision decoder.

5. The method of claim 1, wherein:
using said signal and said decoded signal includes delaying received signal points derived from said signal.

6. The method of claim 1, wherein:
using said signal and said decoded signal includes generating decoded signal points using information from said decoded signal.

7. The method of claim 1, wherein:
using said signal and said decoded signal includes calculating a difference between a decoded signal point and a received signal point associated with said signal, for a first subcarrier.

8. The method of claim 7, wherein:
using said signal and said decoded signal includes calculating a square of a magnitude of said difference for said first subcarrier.

9. The method of claim 1, wherein:
said signal is an orthogonal frequency division multiplexing (OFDM) symbol; and
using said signal and said decoded signal includes calculating an average estimated noise power for a first subcarrier over a number of received OFDM symbols.

10. An apparatus for use in a multicarrier system, comprising:
a demapper to demap received signal points, based on a predetermined signal constellation, to generate demapped information;
a decoder to decode said demapped information to generate decoded information;
a mapper to map said decoded information, based on said predetermined signal constellation, to generate decoded signal points; and
a noise estimator to estimate noise power for individual subcarriers associated with said received signal points using said received signal points and said decoded signal points.

11. The apparatus of claim 10, wherein:
said decoder includes a hard decision unit.

12. The apparatus of claim 10, wherein:
said decoder includes a soft decision unit.

13. The apparatus of claim 10, wherein:
said decoder includes a forward error correction (FEC) decoder.

14. The apparatus of claim 13, wherein:
said decoded information is encoded and interleaved before being applied to said mapper.

15. The apparatus of claim 10, wherein:
said mapper is part of a transmitter chain of said apparatus.

16. The apparatus of claim 15, further comprising:
a switch to direct an output signal of said mapper toward either said noise estimator or an antenna.

17. The apparatus of claim 10, further comprising:
a channel estimator to estimate channel parameters for a wireless channel using said received signal points and said decoded signal points.

18. The apparatus of claim 10, further comprising:
a delay to delay said received signal points before they are delivered to said noise estimator.

19. The apparatus of claim 10, wherein:
said multicarrier system is an orthogonal frequency division multiplexing (OFDM) system; and
said noise estimator determines an average noise over a predetermined number of received OFDM symbols for a first subcarrier.

20. The apparatus of claim 19, wherein:
said noise estimator smooths said average noise in the frequency domain across a group of neighboring subcarriers.

21. A method for use in a multicarrier system, comprising:
demapping received signal points, based on a predetermined signal constellation, to generate demapped information;
decoding said demapped information to generate decoded information;
mapping said decoded information, based on said predetermined signal constellation, to generate decoded signal points; and
estimating noise power for individual subcarriers associated with said received signal points using said received signal points and said decoded signal points.

22. The method of claim 21, wherein:
decoding includes generating hard decisions.

23. The method of claim 21, wherein:
decoding includes generating soft decisions.

24. The method of claim 21, wherein:
decoding includes forward error correction (FEC) decoding said demapped information.

25. The method of claim 24, further comprising:
deinterleaving said demapped information before said forward error correction (FEC) decoding.

26. The method of claim 24, further comprising:
forward error correction (FEC) coding and interleaving said decoded information before said mapping.

27. The method of claim 21, wherein:
estimating noise power includes calculating a difference between a decoded signal point and a received signal point for a first subcarrier.

28. The method of claim 27, wherein:
estimating noise power includes calculating a square of a magnitude of said difference for said first subcarrier.

29. The method of claim 21, wherein:
said multicarrier system is an orthogonal frequency division multiplexing (OFDM) system; and
estimating noise power includes determining an average noise over a predetermined number of received OFDM symbols, for a first subcarrier.

30. The method of claim 21, further comprising:
estimating channel parameters for a wireless channel using said received signal points and said decoded signal points.

31. A system for use in a multicarrier communication system, comprising:
at least one dipole antenna to receive a multicarrier signal from a wireless channel, said multicarrier signal having a number of received signal points;
a demapper to demap said received signal points, based on a predetermined signal constellation, to generate demapped information;
a decoder to decode said demapped information to generate decoded information;
a mapper to map said decoded information, based on said predetermined signal constellation, to generate decoded signal points; and
a noise estimator to estimate noise power for individual subcarriers associated with said received signal points using said received signal points and said decoded signal points.

32. The system of claim 31, wherein:
said decoder includes a hard decision unit.

33. The system of claim 31, wherein:
said decoder includes a soft decision unit.

34. The system of claim 31, wherein:
said decoder includes a forward error correction (FEC) decoder.

35. The system of claim 31, further comprising:
a switch to direct an output signal of said mapper toward either said noise estimator or a transmit antenna.

36. The system of claim 31, further comprising:
a channel estimator to estimate channel parameters for a wireless channel using said received signal points and said decoded signal points.

37. An article comprising a storage medium having instructions stored thereon that, when executed by a computing platform, result in:
obtaining a signal that was received from a wireless channel, said signal being a multicarrier signal;
decoding said signal to generate a decoded signal; and
using said signal and said decoded signal to estimate noise power for individual subcarriers of said signal.

38. The article of claim 37, wherein:
decoding said signal includes forward error correction (FEC) decoding said signal.

39. The article of claim 37, wherein:
decoding said signal includes hard decision decoding said signal.

40. The article of claim 37, wherein:
decoding said signal includes soft decision decoding said signal.
